(19) United States
(12) Patent Application Publication
(10) Pub. No.: US 2025/0329218 A1
(43) Pub. Date: Oct. 23, 2025

(54) REWARDING HEALTHY CASINO BEHAVIOR

(71) Applicant: IGT, Las Vegas, NV (US)

(72) Inventors: Michael Russ, Graz (AT); David Small, Moncton (CA); Sven Aurich, Schwanberg (AT); Stefan Keilwert, St. Josef (AT); Soheil Latifi, Brampton (CA)

(21) Appl. No.: 18/641,893

(22) Filed: Apr. 22, 2024

(51) Int. Cl. G07F 17/32; G06Q 30/0207

(52) U.S. Cl. CPC G07F 17/326; G06Q 30/0207; G07F 17/3239

(57) ABSTRACT

The present disclosure relates generally to a gaming system, device, and method supportive of rewarding responsible gaming behaviors. An illustrative method includes presenting a representation of the electronic game on a display device, where the representation of the electronic game includes displaying a plurality of game features, executing the electronic game, determining, during execution of the electronic game, that a player of the electronic game has taken an action that corresponds to a responsible gaming action, correlating the responsible gaming action to a reward for the player, and presenting information to the player that describes the reward for the player along with instructions for redeeming the reward.

### BACKGROUND

The present disclosure is generally directed toward gaming devices and systems and, more specifically, dynamic game behaviors that incentivize and reward healthy player behavior.

In some gaming systems, an Electronic Gaming Machine (EGM) may include functionality that enables the EGM to modify game play experiences and/or rules in real-time. Most EGMs are configured to incentivize players to use the machine more, regardless of whether or not the player is exhibiting healthy or unhealthy behaviors.

### BRIEF SUMMARY

In certain aspects, the present disclosure relates to a gaming system, method, and machine. In particular, aspects of the present disclosure provide a form of responsible gaming whereby a player may be rewarded when their play behavior is determined to be “healthy.” Traditional responsible gaming solutions currently block or restrict players when their play behavior is deemed to fall outside the definition of healthy or possibly within the definition of “unhealthy”, but restriction measures often lead to craving in humans' psychology. Thus, traditional responsible gaming solutions may initiate further unhealthy gaming behavior. Embodiments of the present disclosure aim to correct these issues and reward players for playing healthy instead of restricting them for playing unhealthy.

Embodiments of the present disclosure incentivize a player when they play healthy. Incentivization may be provided in the form of rewards, examples of which may include, without limitation, cash awards, give aways, collectibles, increased loyalty points, etc. Aspects of this disclosure consider processes and creates outputs based on all factors having an impact on the healthiness of play behavior. “Healthy” behavior may relate to any suitable behavior that otherwise aligns with responsible gaming definitions. Examples of healthy behavior include, but are not limited to, a player wagering money they can afford, a player not behaving too aggressively, a player not becoming too greedy, etc.

An illustrative method of operating an electronic game is provided that includes: presenting, by a processor, a representation of the electronic game on a display device, where the representation of the electronic game includes displaying a plurality of game features; executing, by the processor, the electronic game; determining, during execution of the electronic game, that a player of the electronic game has taken an action that corresponds to a responsible gaming action; correlating the responsible gaming action to a reward for the player; and presenting, by the processor, information to the player that describes the reward for the player along with instructions for redeeming the reward.

A system is provided that includes: a processor; and a memory coupled with and readable by the processor and having stored thereon instructions which, when executed by the processor, cause the processor to: execute an electronic game, where the electronic game presents a plurality of game features to a player during execution thereof; determine, during execution of the electronic game, that the player has taken an action that corresponds to a responsible gaming action; correlate the responsible gaming action to a reward for the player; and present information to the player that describes the reward for the player along with instructions for redeeming the reward.

A gaming device is provided that includes: a display device; a processor coupled with the display device; and a memory coupled with and readable by the processor and having stored thereon instructions which, when executed by the processor, cause the processor to: present a representation of an electronic game on the display device, wherein the representation of the electronic game includes displaying a plurality of game features; execute the electronic game; determine, during execution of the electronic game, that a player of the electronic game has taken an action that corresponds to a responsible gaming action; correlate the responsible gaming action to a reward for the player; and present information to the player that describes the reward for the player along with instructions for redeeming the reward.

Additional features and advantages are described herein and will be apparent from the following Description and the figures.

### BRIEF DESCRIPTION OF THE SEVERAL VIEWS OF THE DRAWINGS

FIG. 1 is a block diagram of a gaming system in accordance with aspects of the present disclosure;

FIG. 2A is a block diagram illustrating a first example data structure used in accordance with aspects of the present disclosure;

FIG. 2B is a block diagram illustrating a second example data structure used in accordance with aspects of the present disclosure;

FIG. 3 is a block diagram of a gaming device in accordance with aspects of the present disclosure;

FIG. 4 is a process flow illustrating a first responsible gaming method in accordance with aspects of the present disclosure;

FIG. 5 is a process flow illustrating a second responsible gaming method in accordance with aspects of the present disclosure;

FIG. 6 is a process flow illustrating a third responsible gaming method in accordance with aspects of the present disclosure;

FIG. 7 is a process flow illustrating a fourth responsible gaming method in accordance with aspects of the present disclosure;

FIG. 8 is a process flow illustrating a fifth responsible gaming method in accordance with aspects of the present disclosure;

FIG. 9 is a process flow illustrating a method of training a responsible gaming model in accordance with aspects of the present disclosure;

FIG. 10 is a process flow illustrating a sixth responsible gaming method in accordance with aspects of the present disclosure;

FIG. 11 is a process flow illustrating a seventh responsible gaming method in accordance with aspects of the present disclosure; and

FIG. 12 is a process flow illustrating an eighth responsible gaming method in accordance with aspects of the present disclosure.

### DETAILED DESCRIPTION

Aspects of the present disclosure will be described in connection improving electronic games and operations thereof associated with promoting responsible gaming behaving. While some examples in the present disclosure may reference the use of an EGM as a gaming device via which players may participate in gaming activity, it should be appreciated that aspects of the present disclosure are not so limited. For example, any device or collection of devices, such as a computing device, personal gaming device, mobile device, personal gaming device, or collection of computing devices may be used to facilitate invoking or facilitate responsible gaming behaviors.

Identifying problem gambling is a complex task, as problem gaming is highly volatile and, relative to player's status, depends on game and momentary outcomes. The issue of problem gambling and other irresponsible gaming behaviors needs to be addressed properly as it can be a gateway to many other problems. To decrease gambling risk and adhere to governmental restrictions and regulations, embodiments of the present disclosure contemplate a safe gambling platform deployed on a gaming device, such as an EGM or mobile device. The device(s) that create an enjoyable experience may benefit from having technical capabilities deployed thereon that incentivize responsible gaming behavior. The actions taken by the device(s) may cause the player to utilize the device less (e.g., a counterintuitive proposition), but there are overall benefits to having the device(s) incentivize responsible gaming behaviors. One measure contemplated herein is to reward healthy players as a preventive measure. Since Artificial Intelligence (AI) and related technologies have proven to be one of the best tools for analyzing time series and detecting underlying behavior and motives, it is a great candidate for the above-noted problem.

Embodiments of the present disclosure contemplate the ability to provide a system that facilitates responsible gaming behaviors. To track responsible gaming behaviors (e.g., “healthy” play behavior), the proposed system may be configured to differentiate between in-game actions and other actions (e.g., non-game actions).

In-game actions that may be tracked according to embodiments described herein are numerous. One non-limiting example of an in-game action that may be tracked by the system includes player spends, which may include determining that the player has played a long time on a device with low money losses. Another example of an in-game action that may be tracked is determining, after a high win (e.g., bonus win, jackpot win, mini-jackpot win, etc.), the player continues playing in their “usual bet behavior” and does not get greedy by turning into a high-risk behavior where chances are high to lose their high win immediately (e.g., the player does not gamble for the whole high win but only parts of it or the player does not change their max bet until the their winnings from the high win have been otherwise lost). Another example of an in-game action that may be tracked is determining that the player does cash out and does not play every single gaming session down to zero credits. Another example of an in-game action that may be tracked is determining that the player (e.g., sometimes) accepts exit-proposals provided by the game (e.g., a message “you should cash out now”—results in the player cashing out).

Other actions that may be tracked according to embodiments described herein are also numerous. Such non-game actions may be tracked in conjunction with in-game actions or may be tracked independent of in-game actions. One non-limiting example of an in-game action that may be tracked by the system includes determining that a player remains calm after losing and does not become aggressive (e.g., smash on the machine or similar). Another example of a non-game action includes determining that the player does not play with the must-have outcome of winning money but rather with the consciousness of “potentially win money but more likely lose it; and therefore, have a nice time in the casino.” As another example, a player may be asked about their motivation to play is (e.g., in a short survey at the game, when assigning for casino loyalty membership, etc.). Another example of a non-game action that may be tracked is determining that a player plays with the money they enter the casino and does not repeatedly draw money from an Automated Teller Machine (ATM). Another example of a non-game action is determining that the player takes a break after series of losses and does not immediately re-cash in or run to another machine. Another example of a non-game action is to monitor player physical reactions (e.g., the player internalizes the same whether they won big or lost big, such as by taking a breath to lean back and internalize what just happened. Another example of a non-game action is monitoring player statements to ensure the player does not make problem statements, such as “the jackpot MUST trigger soon, I feel it.” Another example of a non-game action includes tracking a player's overall casino visit spend and confirming the time spent in the casino is in line with their earnings. Another example of a non-game action includes determining that a player stops playing after they achieved their objectives (e.g., positively or negatively). Another example of a non-game action includes determining that a player does not become too generous with their spendings after drinking alcohol or using some other substance.

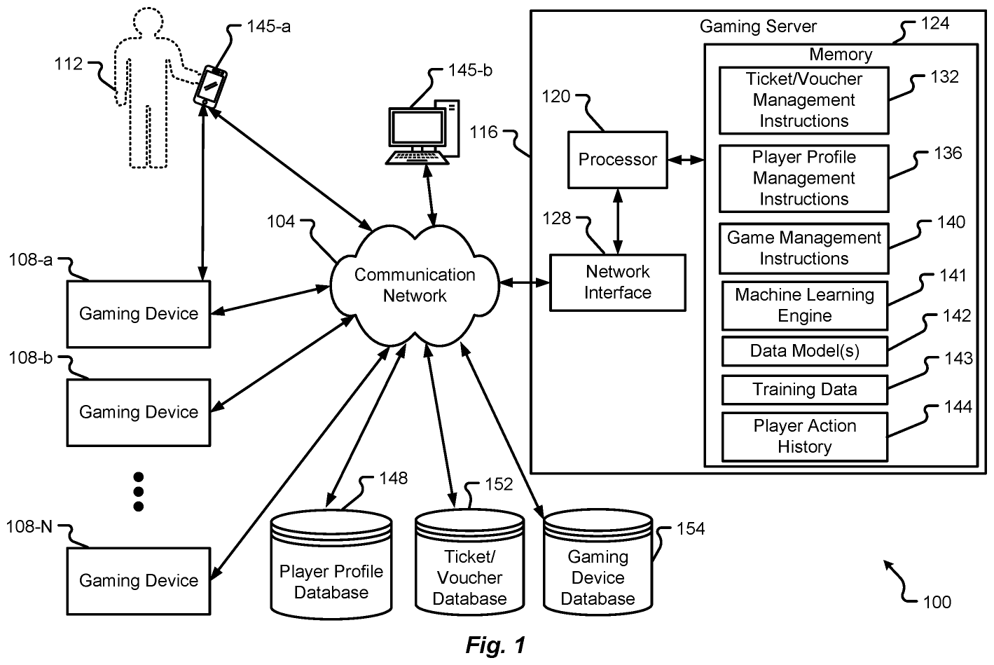

With reference initially to FIG. 1, details of an illustrative gaming system 100 will be described in accordance with at least some embodiments of the present disclosure. The components of the gaming system 100, while depicted as having particular instruction sets and devices, are not necessarily limited to the examples depicted herein. Rather, a system according to embodiments of the present disclosure may include one, some, or all of the components depicted in the gaming system 100 and does not necessarily have to include all of the components in a single device. For example, the components of a server may be distributed amongst a plurality of servers and/or other devices (e.g., a gaming device, a portable/mobile user device, etc.) in the gaming system 100 without departing from the scope of the present disclosure.

The gaming system 100 may include a communication network 104 that interconnects and facilitates machine-to-machine communications between one or multiple gaming devices 108 (e.g., any of gaming device 108-a through 108-N) and a gaming server 116. It should be appreciated that the communication network 104 may correspond to one or many communication networks without departing from the scope of the present disclosure. In some embodiments, gaming device 108-a through gaming device 108-N and gaming server(s) 116 may be configured to communicate using various nodes or components of the communication network 104. The communication network 104 may include any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may include a number of different communication media such as coaxial cable, copper cable/wire, fiber-optic cable, antennas for transmitting/receiving wireless messages, and combinations thereof.

In some embodiments, the gaming devices 108 (e.g., gaming device 108-a through gaming device 108-N) may be distributed throughout a single property or premises (e.g., a single casino floor), or the gaming devices 108 (e.g., gaming device 108-a through gaming device 108-N) may be distributed among a plurality of different properties. In a situation where the gaming devices 108 are distributed in a single property or premises, the communication network 104 may include at least some wired connections between network nodes. As a non-limiting example, the nodes of the communication network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, etc.

The gaming devices 108 (e.g., gaming device 108-a through gaming device 108-N) may utilize the same or different types of communication protocols to connect with the communication network 104. It should also be appreciated that the gaming devices 108 (e.g., gaming device 108-a through gaming device 108-N) may present the same type of game or different types of games to a player 112. For example, the gaming device 108-a may correspond to a gaming machine that presents a slot game to the player 112, the gaming device 108-b may correspond to a video poker machine, and other gaming devices 108 may present other types of games (e.g., keno, sports wagering, etc.) or a plurality of different games for selection and eventual play by the player 112.

In some aspects, some of the gaming devices 108 (e.g., gaming device 108-a through gaming device 108-N) may communicate or exchange data with one another via the communication network 104. In some embodiments, one or more of the gaming devices 108 may be configured to communicate directly with a centralized management server and/or the gaming server 116. Although not depicted, the gaming system 100 may include a separate server or collection of servers that are responsible for managing the operation of the various gaming devices 108 in the gaming system 100.

It should also be appreciated that the gaming server 116 may or may not be co-located with one or more gaming devices in the same property or premises. Thus, one or more gaming devices 108 may communicate with the gaming server 116 over a WAN, such as the Internet. In such an event, a tunneling protocol or Virtual Private Network (VPN) may be established over a portion of the communication network 104 to ensure that communications between a gaming device 108 and the server 116 (e.g., a remotely-located server) are secured.

The gaming devices 108 (e.g., gaming device 108-a through gaming device 108-N) may correspond to a type of device that supports interaction by a player 112 in connection with playing games of chance. Examples of a gaming device 108 may include any type of known gaming device such as an EGM, a slot machine, a table game, an electronic table game (e.g., video poker), a skill-based game, etc. In addition to playing games on a gaming device 108, the player 112 may also be allowed to interact with and play games of chance on a communication device 145a or communication device 145b.

The gaming system 100 may support interaction with one or more communication devices 145. A communication device 145 (e.g., communication device 145-a) may be a mobile device of a player 112 (e.g., a personal communication device such as a smart phone, a tablet, a smart watch, etc.) or to a device issued by a casino to the player 112. It should be appreciated that the player 112 may play games directly on the communication device 145. Alternatively, or additionally, the communication device 145 may establish a communication link (e.g., over a wireless or wired connection) with a gaming device 108 such that the communication device 145 provides an interface for the player 112 to interact with the gaming device 108. As shown in FIG. 1, the communication device 145 may be in communication with the communication network 104 or in direct communication (e.g., via Bluetooth, WiFi, etc.) with a gaming device 108. Non-limiting examples of a communication device 145 include a cellular phone, a smart phone, a tablet, a wearable device, an augmented reality headset, a virtual reality headset, a laptop, a Personal Computer (PC), or the like. In some cases, another communication device 145 (e.g., communication device 145-b) may be a mobile device, a PC, or the like of a casino operator (e.g., a floor attendant, a casino manager, etc.).

In some cases, the gaming system 100 may support “carding in” of a player at a gaming device 108 with a physical card (e.g., a player club card). In other cases, the gaming system 100 may support “carding in” of a player at a gaming device 108 via a mobile application on a communication device 145. In some aspects, the mobile application may support fund transfers between a player account and the gaming device 108 (e.g., a server, the casino). For example, using the mobile application, the player may transfer funds to a gaming session.

In an example of “carding in,” the communication device 145 may exchange information with the gaming device 108 over a wireless connection (e.g., near field communication (NFC), Bluetooth, etc.) when the communication device 145 is within a threshold distance of the gaming device 108. In another aspect, the communication device 145 may “card in” and exchange information with the gaming device 108 when the communication device 145 is connected to the gaming device 108 using a physical communications link (e.g., a communications cable). In an example, when “carding in,” the communication device 145 may provide player identification information (e.g., player identity, player club status, player preference information, etc.) to the gaming device, the server, and/or the gaming system. The gaming server 116 (or the gaming device 108) may establish a gaming session at the gaming device 108 for the player based on the information provided during the “card in”.

The gaming server 116 is further shown to include a processor 120, a memory 124, and a network interface 128. These resources may enable functionality of the gaming server 116 as will be described herein. For example, the network interface 128 provides the server 116 with the ability to send and receive communication packets or the like over the communication network 104. The network interface 128 may be provided as a network interface card (NIC), a network port, drivers for the same, and the like. Communications between the components of the server 116 and other devices connected to the communication network 104 may all flow through the network interface 128.

The processor 120 may correspond to one or many computer processing devices. For example, the processor 120 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 120 may be provided as a microprocessor, Central Processing Unit (CPU), a Graphics Processing Unit (GPU), or plurality of microprocessors that are configured to execute the instructions sets stored in memory 124. Upon executing the instruction sets stored in memory 124, the processor 120 enables various authentication functions of the gaming server 116.

The memory 124 may include any type of computer memory device or collection of computer memory devices. The memory 124 may be volatile or non-volatile in nature and, in some embodiments, may include a plurality of different memory devices. Non-limiting examples of memory 124 include Random Access Memory (RAM), Read Only Memory (ROM), flash memory, Electronically-Erasable Programmable ROM (EEPROM), Dynamic RAM (DRAM), etc. The memory 124 may be configured to store the instruction sets depicted in addition to temporarily storing data for the processor 120 to execute various types of routines or functions. Although not depicted, the memory 124 may include instructions that enable the processor 120 to store data to and retrieve data from a player profile database 148, a ticket/voucher database 152, and/or a gaming device database 154.

Alternatively or additionally, the player profile database 148 or data stored thereon may be stored internal to the any of the communication device 145, a gaming device 108, and/or the server 116 (e.g., within the memory 124 of the server 116 rather than in a separate database). Alternatively or additionally, the ticket/voucher database 152 or data stored therein may be stored internal to the server 116. Alternatively or additionally, the gaming device database 154 or data stored thereon may be stored internal to the server 116.

The databases described herein (e.g., player profile database 148, ticket/voucher database 152, gaming device database 154) may include a relational database, a centralized database, a distributed database, an operational database, a hierarchical database, a network database, an object-oriented database, a graph database, a NoSQL (non-relational) database, etc. In some aspects, the databases may store and provide access to, for example, any of the stored data described herein.

The illustrative instruction sets that may be stored in memory 124 include, without limitation, a ticket/voucher management instruction set 132, a player profile management instruction set 136, and a game management instruction set 140. Functions of the server 116 enabled by these various instruction sets will be described in further detail herein. It should be appreciated that the instruction sets depicted in FIG. 1 may be combined (partially or completely) with other instruction sets or may be further separated into additional and different instruction sets, depending upon configuration preferences for the server 116. Said another way, the instruction sets depicted in FIG. 1 should not be construed as limiting embodiments described herein.

In some embodiments, the ticket/voucher management instruction set 132, when executed by the processor 120, may enable the gaming server 116 to manage various tickets/vouchers issued by gaming devices 108 (e.g., gaming device 108-a through gaming device 108-N), manage ticket/voucher values, determine ticket/voucher states, update the ticket/voucher database 152, obtain information from the ticket/voucher database 152, determine that a ticket/voucher has been redeemed and notify the player profile management instruction set 136, etc. In embodiments where the ticket/voucher instruction set 132 is implemented in one system (e.g., a ticketing/voucher system) and the player profile management instruction set 136 is implemented in a separate system (e.g., a player tracking system), a communication link may or may not be implemented between the two systems. In such a situation, the tickets/vouchers issued by the ticketing/voucher system may be anonymous and not necessarily associated with any particular player or player profile.

In some embodiments, the ticket/voucher management instruction set 132 may be configured to perform any action consistent with the issuance of tickets/vouchers, tracking of ticket/voucher states, and determining whether/when/where a ticket/voucher has been redeemed. In some embodiments, the ticket/voucher management instruction set 132 may be configured to generate, or cause the game management instruction set 140 to generate, a synthesized credit meter for the first gaming device. For example, as gaming devices 108 (e.g., gaming device 108-a through gaming device 108-N) or a communication device 145 have their credit meters updated, the gaming server 116 may update a corresponding synthesized credit meter to reflect updates at the credit meters. In some embodiments, values of credit or other events stored in credit meters of gaming device 108 and/or a communication device 145 may be mirrored in a synthesized credit meter maintained by the gaming server 116.

The player profile management instruction set 136, when executed by the processor 120, may enable the gaming server 116 to manage one or more player profiles within the player profile database 148. In some embodiments, the player profile management instruction set 136 may be configured to manage a player loyalty profile including settings for such player profiles, available wager credits for such profiles, determine player wager history, retrieve a player action history 144 associated with a player 112, and/or determine which, if any, tickets/vouchers are associated with a particular player 112. It should also be appreciated that the player profile management instruction set 136 may be configured to manage player profiles of players that do not have loyalty accounts or any other predetermined player account. As will be described in further detail herein, the player profile management instructions 136 may cooperate with instructions on a gaming device 108 to facilitate or enable responsible gaming behaviors.

In some aspects, the player profile management instruction set 136 may be configured to manage a player action history 144 associated with gameplay sessions. In an example, the player action history 144 may include user behavior (e.g., gameplay decisions) associated with previous and/or current gameplay sessions. In some other examples, the player action history 144 may include descriptions of actions (e.g., in-game and non-game actions) that are taken by a particular player 112 and the context surrounding such actions. The player action history 144 may, in some embodiments, be used to determine or define a normal gaming behavior for a player 112 (e.g., a baseline behavior) such that deviations from the normal gaming behavior for the player 112 can be potentially be identified as irresponsible gaming behaviors. Conversely, a player's 112 current actions that align with a healthy baseline behavior may be identified as responsible gaming behaviors and, in some embodiments, may be rewarded.

The game management instruction set 140, when executed by the processor 120, may enable the gaming server 116 to manage the various games played by a player 112 at the gaming devices 108 (e.g., gaming device 108-a through gaming device 108-N) and/or a communication device 145 carried by the player 112. For example, any game played by the player 112 at any of the gaming devices 108 and/or communication device 145 may be managed, partially or entirely, by execution of the game management instruction set 140. The game management instruction set 140 may also be configured to track a status of wager events (e.g., non-EGM wager games, sporting events, bingo, keno, lottery, etc.) and whether a player 112 has placed a wager on such events. In some embodiments, when a wager event has come to completion such that wagers made on the event become payable (e.g., at the end of a gameplay decision at a gaming device 108 and/or communication device 145, at the end of a sporting event when the final score of the event is determined), the game management instruction set 140 may notify the ticket/voucher management instruction set 132, thereby enabling the ticket/voucher management instruction set 132 to update states and/or values of tickets/vouchers issued for the event appropriately.

In some aspects, the game management instruction set 140, when executed by the processor 120, may enable the gaming server 116 to manage and/or monitor data associated with a gameplay session at a gaming device 108. For example, the gaming server 116 may support example aspects described herein of monitoring user information (e.g., member identification information, player club status, etc.), gameplay data (e.g., quantity of plays, quantity of spins, duration of gameplay, credits spent, credits earned, etc.), and actions (e.g., in-game and non-game actions) associated with a gameplay session at the gaming device 108.

In an example, the gaming server 116 may support example aspects described herein of identifying historical data (e.g., previous gameplay decisions) associated with previous gameplay sessions at gaming devices 108. In another example, the gaming server 116 may support example aspects described herein of identifying current data (e.g., gameplay decisions) associated with a current gameplay session at a gaming device 108. The gaming server 116 may provide any of the historical data and/or current data to a machine learning engine 141 (e.g., as inputs to a data model(s) 142, as training data 143, etc.), example aspects of which are described herein. In some aspects, gameplay decisions may be associated with decision events such as wager selections, gameplay choices (e.g., a player decision in a video poker game, selected pay lines at a slot machine, etc.), bonus/prize selections, etc.

In some examples, the game management instruction set 140 may cooperate with the player profile management instruction set 136 to identify actions corresponding to responsible gaming behaviors. The game management instruction set 140 and player profile management instruction set 136 may also cooperate to correlate the responsible gaming behaviors to one or more rewards for the player 112. Such rewards may include in-game reward and/or non-game rewards.

According to example aspects of the present disclosure, the processor 120 may utilize data stored in the memory 124 as a neural network. The neural network may be, for example, a machine learning network and may include a machine learning architecture. In some aspects, the neural network may be or include an artificial neural network (ANN). In some other aspects, the neural network may be or include any machine learning network such as, for example, a deep learning network, a convolutional neural network, or the like. Some or all of instructions or instruction sets stored in the memory 124 and some functions of the gaming server 116, gaming devices 108, and/or communication devices 145 may be implemented using machine learning techniques. In some cases, the machine learning techniques may include deep learning and reinforcement learning.

In some embodiments, the data model(s) 142 may include one or more responsible gaming models that are specifically trained to support an identification of responsible gaming behaviors and/or irresponsible gaming behaviors. As a non-limiting example, a data model 142 implemented as a responsible gaming model may include a recurrent neural network. In some embodiments, the training data 143 used to train such a data model 142 may include the Nth latest actions and outcomes of the player(s) 112 with which the data model 142 is associated. The data model 142, in some embodiments, may be determined ready for use within the gaming server 116 when an optimal number of actions are determined that is not too wide (high accuracy, but means it takes more actions to detect behaviors) or too short (low accuracy but fast response from the model).

The recurrent neural network may be trained on randomly selected sequences from one or many gaming sessions. In some embodiments, these sequences can be rated by experts, the rating showing the degree of risk associated with the session. The training window is changed during each training session so that it can be determined how many transactions are needed for assessing risky behavior. After training, the data model 142 implemented as the responsible gaming model can rank future gaming sessions based on riskiness and/or problematic behavior. As for the model architecture, either long short term memory models or transformers based on their performance can be used.

In some aspects, the neural network may support K-means clustering of training data 143. For example, the training data 143 may include gameplay data and player behavior (e.g., player decisions) associated with previous gameplay sessions at gaming devices 108 (e.g., based on game type, based on a player profile, etc.). In some examples, the training data 143 may include gameplay data and player behavior (e.g., player decisions) associated with a current gameplay session at a gaming device 108. For example, the training data 143 may include previous data (e.g., gameplay data, player behavior, gameplay decisions, etc.) from the same player as well as previous data (e.g., gameplay data, player behavior, gameplay decisions, etc.) from other players (e.g., similar players, players having similar playstyle characteristics, etc.) in the venue.

In an example, the training data 143 may include a dataset (e.g., gameplay data, player behavior, etc.), and the neural network may implement a K-means algorithm which includes iteratively partitioning the dataset into K pre-defined, distinct, non-overlapping subgroups (also referred to herein as clusters or playstyles) where each data point belongs to only one subgroup. In some cases, implementation of the K-means algorithm may include partitioning the dataset such that intra-cluster data points are as similar as possible (e.g., within a threshold criteria) while clusters are as different (e.g., far, in accordance with a threshold distance) as possible.

In an example, the clusters may be identifiable from the analyzed dataset (e.g., gameplay data) based on a set of features pre-defined at the gaming system 100. In some aspects, the gaming system 100 may support defining and/or modifying (e.g., redefining, reconfiguring) the set of features at the gaming server 116 or a communication device 145 (e.g., by a casino establishment, a casino manager, etc.).

Example features include: a credit amount at the start of a gameplay session (e.g., ‘SumCashInAmount’), a credit amount at the end of a gameplay session (e.g., ‘SumCashOutAmount’), quantity of wager adjustments during a temporal period and/or during a gameplay session (e.g., ‘No. of bet changes’), a ratio of a wager amount to a player bankroll (e.g., ‘Wager-Bank-Ratio’), gameplay duration associated with gameplay session (e.g., ‘TimePlayed’), average wager amount for a primary game (base game) (e.g., ‘AverageWagerPrimary’), an average win amount associated with a primary game (e.g., ‘AveragePrimaryWinAmount’), quantity of primary games played during a temporal period and/or during a gameplay session (e.g., ‘No.PrimaryGamesPlayed’), quantity of secondary games (bonus games) played during a temporal period and/or during a gameplay session (e.g., ‘No. SecondaryGamesPlayed), or the like.

The memory 124 may be configured to store program instructions (instruction sets) that are executable by the processor 120 and provide functionality of a machine learning engine 141. The memory 124 may also be configured to store data or information that is useable or capable of being called by the instructions stored in memory 124. One example of data that may be stored in memory 124 for use by components thereof is a data model(s) 142 and/or training data 143. The data model(s) 142 may be a neural network model. The training data 143 may include training data and feedback.

The machine learning engine 141 may include a single or multiple engines. The gaming server 116 (e.g., the machine learning engine 141) may utilize one or more data models 142 for recognizing and processing information obtained from gaming devices 108, communication devices 145, other servers, and/or databases (e.g., player profile database 148, gaming device database 154, ticket/voucher database 152). In some aspects, the gaming server 116 (e.g., the machine learning engine 141) may update one or more data models 142 based on learned information included in the training data 143. In some aspects, the machine learning engine 141 and the data models 142 may support forward learning based on the training data 143. The machine learning engine 141 may have access to and use one or more data models 142. For example, the data model(s) 142 may be built and updated by the machine learning engine 141 based on the training data 143. The data model(s) 142 may be provided in any number of formats or forms. Non-limiting examples of the data model(s) 142 include autoregressive models, Decision Trees, Random Forest, Support Vector Machines (SVMs), Nearest Neighbor, and/or Bayesian classifiers.

The training data 143 may include any data managed by the gaming server 116 with respect to the ticket/voucher management instruction set 132, the player profile management instruction set 136, and/or the game management instruction set 140 described herein. For example, the training data 143 may include player histories (e.g., gameplay data, player behavior, etc.) associated with gameplay sessions at a gaming device(s) 108. In some aspects, the training data 143 may be stored (e.g., in the memory 124, a database, etc.) according to player profile and/or game type. In some examples, the training data 143 may include player histories (e.g., player action history 144). In some aspects, the machine learning engine 141 may be configured to analyze aggregated player histories, gameplay data, in-game actions, and non-game actions, that are historical or in real-time.

The machine learning engine 141 may build any number of configuration profiles (e.g., player profiles, gaming device 108 profiles, playstyle profiles) using automatic processing, using artificial intelligence and/or using input from one or more users associated with the communication device 145. The machine learning engine 141 may use automatic processing, artificial intelligence, and/or inputs from one or more users of the communication devices 145 to determine, manage, and/or combine information relevant to a configuration profile. Example aspects of such configuration profiles are described in further detail below.

The machine learning engine 141 may determine configuration profile information based on a user's interactions with information. The machine learning engine 141 may update (e.g., continuously, periodically, etc.) configuration profiles based on new information that is relevant. The machine learning engine 141 may receive new information from any communication device 145, the gaming server 116, any database described herein, etc. Profile information may be organized and classified in various manners. In some aspects, the organization and classification of configuration profile information may be determined by automatic processing, by artificial intelligence and/or by one or more users of a communication device 145 (e.g., a player, casino personnel, a casino manager, etc.).

In an example, the gaming server 116, a gaming device 108 and/or a communication device 145 may provide, to the machine learning engine 141, gameplay data and/or user information associated with a gameplay session (e.g., previous or current) at the gaming device 108. In an example, the gameplay data may include a quantity of plays (e.g., number of spins), duration of gameplay, credits spent, credits earned, etc. In some examples, the user information may include player identification information (e.g., stored on a player identification card, associated with a player access code, stored on a communication device 145 of a player, etc.).

Data within the database of the memory 124 may be updated, revised, edited, or deleted by the machine learning engine 141. In some aspects, the machine learning engine 141 may support continuous, periodic, and/or batch fetching of data (e.g., from gaming devices 108, communication devices 145, databases, servers, etc.) and data aggregation.

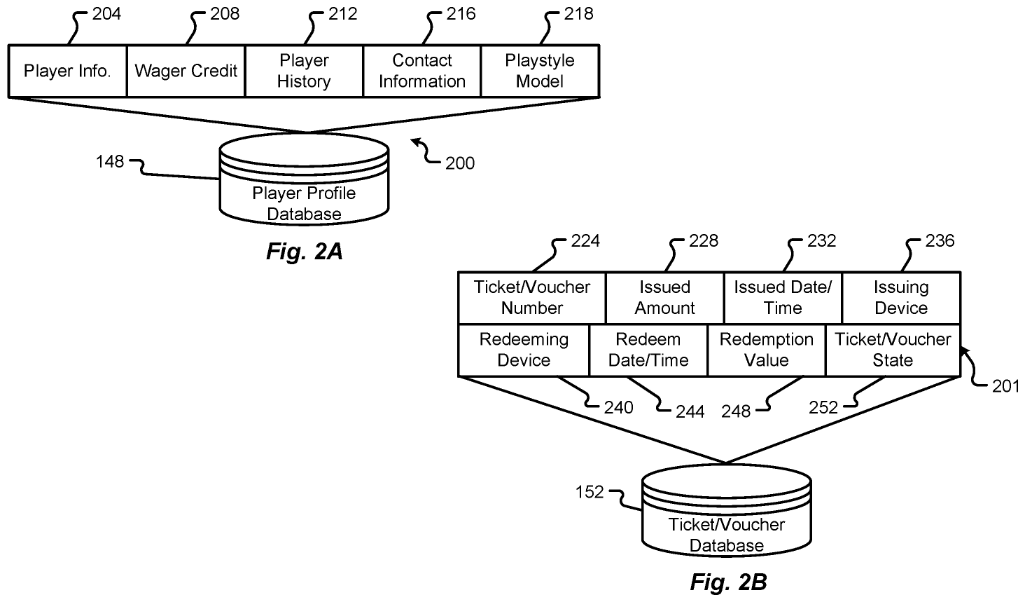

With reference now to FIGS. 2A and 2B, additional details of data structures that are useable in connection with managing auto play modes and playstyle models at a gaming device will be described in accordance with at least some embodiments of the present disclosure. It should be appreciated that the data structures depicted and described herein may be stored within a central database or may be distributed among a number of data storage nodes. Alternatively or additionally, some or all of the fields of the data structures may be maintained in devices of the gaming system 100 such as the gaming server 116, a gaming device 108, and/or a communication device 145 without departing from the scope of the present disclosure.

With reference initially to FIG. 2A, details of a data structure 200 that may be maintained as part of a player profile will be described in accordance with at least some embodiments of the present disclosure. The database 148 may be configured to store one or multiple data structures 200 that are used in connection with tracking player progress and gaming history. In some embodiments, the data stored in the data structure 200 may be stored for a plurality of different player profiles or for a single player profile. As a non-limiting example, the data structure 200 may be used to store player loyalty information, player history information, and the like. Even more specifically, the data structure 200 may include a plurality of data fields that include, for instance, a player information field 204, a wager credit field 208, a player history field 212, a contact information field 216, and a playstyle model field 218.

The player information field 204 may be used to store any type of information that identifies a player or a group of players. In some embodiments, the player information field 204 may store one or more of username information for a player 112, password information for a player account, player status information, accommodations associated with the player 112, and any other type of customer service management data that may be stored with respect to a player 112.

The wager credit field 208 may be used to store data about the available credit of a player 112 with a device, with a sports book, with a casino, and/or with a plurality of casinos. For instance, the wager credit field 208 may store an electronic record of available credit in the player's account and whether any restrictions are associated with such credit. The wager credit field 208 may further store information describing a player's available credit over time, cash out events for the player, winning events for the player 112, wagers placed by the player 112, tickets/vouchers issued to the player 112, and the like.

The player history field 212 may be used to store historical data for events that occur with respect to the player 112. For example, the player history field 212 may store information associated with the player 112 in relation to an outcome in a game of chance, an outcome in a game of skill, a celebration event for a person other than the player 112, involvement in a celebration event, visits to a predetermined location, gameplay information with respect to a particular game, player interactions with a communication device 145, player interactions (e.g., gameplay decisions) with a gaming device 108, wagers placed by the player 112, tickets/vouchers issued for the player 112, tickets/vouchers redeemed by the player 112, etc.

In some other examples, the player history field 212 may store user actions taken by a user. Illustratively and without limitation, the player history field 212 may store information describing in-game actions and non-game actions that are taken by the player 112. The player history field 212 may include data describing a baseline gaming behavior that is unique to the player 112, responsible gaming behavior that is unique to the player 112, and/or irresponsible gaming behavior that is unique to the player 112.

The contact information field 216 may store information associated with a preferred mode(s) of contact for the player 112 and how such contact can be made. For instance, the contact information field 216 may store information such as an email address, phone number, room number, player loyalty number, address, etc.

The playstyle model field 218 may store user decisions by the player 112 in relation to instances of a player 112 responding to rewards for responsible gaming behavior. The playstyle model field 218 may also store information describing when/if a player 112 declines to accept a responsible gaming behavior reward or declined a responsible gaming behavior reward in exchange for a potentially greater reward in the future.

With reference now to FIG. 2B, details of another data structure 201 that may be used within the gaming system 100 will be described in accordance with at least some embodiments of the present disclosure. The database 152 may be configured to store one or multiple data structures 201 that are used in connection with tracking ticket/voucher status, value, and the like. In some cases, the data structures 201 may be used in connection with tracking credits associated with a gameplay session at a gaming device 108. In some other cases, the data structures 201 may be used in connection with tracking credits earned and/or credits lost at a gaming device 108 in association with an invoked auto play mode, a playstyle model applied to the auto play mode, etc.

In some embodiments, the data stored in the data structure 201 may be stored for a plurality of different tickets/vouchers and may or may not be organized based on events, player association, etc. As a non-limiting example, the data structure 201 may be used to store ticket/voucher status information, ticket/voucher value information, and the like. The ticket/voucher value information may include credit information associated with a gameplay session at a gaming device 108.

In an example, the data structure 201 may include a plurality of data fields that include, for instance, a ticket/voucher number field 224, an issued amount field 228, an issued date/time field 232, an issuing device field 236, a redeeming device field 240, a redeem date/time field 244, a redemption value field 248, and a ticket/voucher state field 252. It should be appreciated that the data structure 201 may have greater or fewer fields than depicted in FIG. 2B.

The ticket/voucher number field 224 may be used to store a unique validation number assigned to the ticket/voucher when a ticket/voucher is issued to a player 112. In some embodiments, the data stored in the ticket/voucher number field 224 may be randomly generated, pseudo-randomly generated, or sequentially generated based on when the ticket/voucher is issued. In some embodiments, the validation number assigned to the ticket/voucher may be unique to the ticket/voucher within the gaming system 100 (e.g., at least unique as to any other ticket/voucher issued within the gaming system 100). While numeric values may be used for the validation number, it should be appreciated that any alphanumeric string may be used for the validation number stored in the ticket/voucher number field 224.

The issued amount field 228 may be used to store an electronic record of a monetary value for which the particular ticket/voucher was issued. The issued amount field 228 may correspond to a data field that is written once and not updated. Thus, even when an associated ticket/voucher transitions from the issued state to another state, the value recorded in the issued amount field 228 may be left unchanged. Likewise, the information stored in the issued date/time field 232 and issuing device field 236 may also be written once and not changed thereafter. The issued date/time field 232 may store information describing when a ticket/voucher is issued, whereas the issuing device field 236 may store information describing where a ticket/voucher is issued. For instance, the issuing device field 236 may indicate a unique serial number assigned to a gaming device 108 that was used to issue the ticket/voucher to the player 112 and the issued date/time field 232 may store the time at which the ticket/voucher was issued by the gaming server 116 and/or the gaming device 108.

In some embodiments, the date/time field 232 may be populated based on a clock of the gaming device 108 that issued the ticket/voucher rather than relying on the clock of the gaming server 116. Said another way, when a gaming device 108 issues a ticket/voucher, such information may be communicated back to the gaming server 116 along with a timestamp provided by the gaming device 108 to indicate a time at which the gaming device 108 issued the ticket/voucher. Using the time indicated by the gaming device 108 can help account for or avoid problems associated with delays in communication over the communication network 104. One such possible problem would be having a wagered event (e.g., a sporting event) come to completion while the communication network 104 is down or unavailable and before the gaming server 116 becomes aware of an issued ticket/voucher by a gaming device 108. Alternatively, or additionally, it may also be possible or desirable to use the clock of the gaming server 116 as the centralized authority on all date/times entered into the field 232, thereby avoiding the need to synchronize or consider synchronization issues between different gaming devices 108.

Like the issuing device field 236, the redeeming device field 240 may be used to store information describing a device at which a ticket/voucher is redeemed by a player 112. Alternatively, or additionally, the redeeming device field 240 may be used to store information describing a communication device 145 via which a player 112 may redeem credits associated with a gameplay session or a player profile. In some embodiments, a device used for redeeming a ticket/voucher or credits may correspond to a gaming device 108 or a communication device 145.

A player 112 may redeem a ticket/voucher at a gaming device 108 by inserting a printed ticket/voucher into a ticket acceptance device of the gaming device 108 (e.g., similar to a bill acceptor). A player 112 may redeem a ticket/voucher at a communication device 145 by scanning the ticket/voucher with a camera of the communication device 145 and transmitting information obtained from the scan of the ticket/voucher back to the gaming server 116 as proof of redemption. Alternatively, or additionally, in the example case of an electronic ticket/voucher (e.g., an e-TITO voucher), a player 112 may to redeem the electronic ticket/voucher at a gaming device 108 or a communication device 145 by using an RFID reader that is in electronic communication with (e.g., electrically coupled to) the gaming device 108 or the communication device 145.

Thus, the redeeming device field 240 may store information uniquely describing the device used by the player 112 to redeem a ticket/voucher (e.g., an address or device ID). Alternatively or additionally, the redeeming device field 240 may store information describing a type of device that was used for redemption (e.g., whether the device is a gaming device 108 or a communication device 145).

The redemption date/time field 244, similar to the issued date/time field 232, may be used to store data and/or time information for the ticket/voucher. For example, the redemption date/time field 244 may be used to store a date/time when a ticket/voucher is redeemed as opposed to when the ticket is issued. Again, the time indicated in the field 244 may be based on a timestamp issued by the redeeming device and/or a clock of the gaming server 116. The date/time provided in the data field 244 may correlate to a date/time when the state of the ticket transitions within the ticket/voucher state field 252.

When the electronic record of the ticket/voucher state 252 is updated, a change to the date/time in field 244 may also be made at substantially the same time. As will be discussed in further detail herein, the ticket/voucher state field 252 may be used to store state or status information for a ticket/voucher and the state within the field 252 may be capable of having at least three different values (e.g., issued, redeemable, and redeemed). Other possible values for the state of the ticket/voucher may include, without limitation, a pending state, which may correspond to a state between the issued state and the redeemable state where a wagered event has come to completion but the redeemable value of the ticket/voucher is still being determined and/or considered.

The redemption value field 248 may be used to store an electronic record indicating an amount for which a ticket/voucher may be redeemed (e.g., a redeemable value) and/or an amount for which a ticket/voucher is actually redeemed (e.g., a redeemed/redemption amount). In embodiments where the redeemable value is the same as the redeemed/redemption value, there may only need to be a single data field 248 to store the redemption value for the ticket/voucher. In some embodiments, it may also be desirable to have separate data fields to store a redeemable value for a ticket/voucher and then a redeemed/redemption value for the ticket/voucher. The redeemable value for a ticket/voucher may be determined by the gaming server 116 as soon as the wagered event for which the ticket/voucher is associated has come to completion whereas the redemption value may be determined by the gaming server 116 when the ticket/voucher is redeemed. Again, the redemption value may be the same as or different from the redeemable value without departing from the scope of the present disclosure.

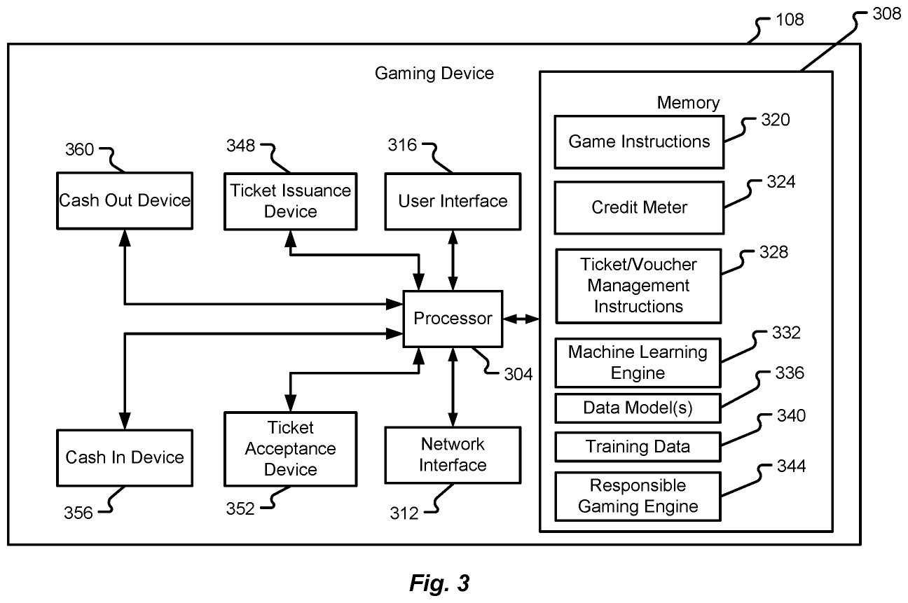

With reference now to FIG. 3, additional details of a gaming device 108 will be described in accordance with at least some embodiments of the present disclosure. While depicted as a gaming device 108, it should be appreciated that some or all of the components of the gaming device 108 may be included in a mobile device 144 described herein without departing from the scope of the present disclosure.

The gaming device 108 is depicted to include a processor 304, memory 308, a network interface 312, a user interface 316, a ticket issuance device 348, a ticket acceptance device 352, a cash-in device 356, and a cash-out device 360. In some embodiments, the processor 304 may include example aspects of the processor 120. In other words, the processor 304 may correspond to one or many microprocessors, CPUs, GPUs, microcontrollers, or the like. The processor 304 may be configured to execute one or more instruction sets stored in memory 308.

The network interface 312 may include example aspects of network interface 128. The nature of the network interface 312, however, may depend upon whether the network interface 312 is provided in a gaming device 108 or a communication device 145. Examples of a network interface 312 include, without limitation, an Ethernet port, a USB port, an RS-232 port, an RS-485 port, a NIC, an antenna, a driver circuit, a modulator/demodulator, etc. The network interface 312 may include one or multiple different network interfaces depending upon whether the gaming device 108 is connecting to a single communication network 104 or multiple different types of communication networks 104. For instance, the gaming device 108 may be provided with both a wired network interface and a wireless network interface without departing from the scope of the present disclosure.

The user interface 316 may correspond to any type of input and/or output device that enables the player 112 to interact with the gaming device 108. As can be appreciated, the nature of the user interface 316 may depend upon the nature of the gaming device 108. For instance, if the gaming device 108 is a traditional mechanical reel slot machine, then the user interface 316 may include one or more mechanical reels with symbols provided thereon, one or more lights or LED displays, one or more depressible buttons, a lever or “one armed bandit handle”, a speaker, or combinations thereof. If the gaming device 108 is a digital device, then the user interface 316 may include one or more touch-sensitive displays, LED/LCD display screens, etc. In some cases, the user interface 316 may include a combination of a physical interface (e.g., mechanical reels, depressible buttons, a lever, etc.) and other user interfaces (e.g., touch-sensitive displays, LED/LCD display screens, etc.). In some cases, the user interface 316 may include a biometric scanning device (e.g., a fingerprint scanner) supportive of biometric inputs by a user.

The memory 308 may include example aspects of memory 124. For instance, the memory 308 may include one or multiple computer memory devices that are volatile or non-volatile. The memory 308 may be configured to store instruction sets that enable player interaction with the gaming device 108, that enable game play at the gaming device 108, and/or that enable coordination with the gaming server 116. Examples of instruction sets ort data that may be stored in the memory 308 include a game instruction set 320, a credit meter 324, a ticket/voucher management instruction set 328, and a responsible gaming engine 344.

In some embodiments, the game instruction set 320, when executed by the processor 304, may enable the gaming device 108 to facilitate one or more games of chance or skill and produce interactions between the player 112 and the game of chance or skill. In some embodiments, the game instruction set 320 may include subroutines that present one or more graphics to the player 112 via the user interface 316, subroutines that calculate whether a particular wager has resulted in a win or loss during the game of chance or skill, subroutines for determining payouts for the player 112 in the event of a win, subroutines for exchanging communications with a connected server (e.g., game management server, gaming server 116, or the like), subroutines for enabling the player 112 to engage in a game using their communication device 145, and any other subroutine or set of instructions that facilitate gameplay at or in association with the gaming device 108.

In some aspects, the game instruction set 320, when executed by the processor 304, may enable the gaming device 108 to call or utilize the responsible gaming engine 344. For instance, as part of promoting and rewarding responsible gaming behavior, the game instruction set 320 may interact with the responsible gaming engine 344 to monitor actions (e.g., in-game and non-game actions) during a gaming session, determine whether any such actions correspond to a responsible gaming action, correlate responsible gaming actions to a reward for the player involved in the gaming session, and then present information to the player 112 that describes the reward along with instructions for reward redemption. The responsible gaming engine 344 may also be configured to interact with the gaming server 116 by utilizing data model(s) 142 stored thereon (e.g., responsible gaming model) and/or by retrieving player action history 144 for the player involved in the gaming session.

The credit meter 324 may correspond to a secure instruction set and/or data structure within the gaming device 108 that facilitates a tracking of activity at the gaming device 108. In some embodiments, the credit meter 324 may be used to store or log information related to various activities of a player 112 and events that occur at the gaming device 108. The types of information that may be maintained in the credit meter 324 include, without limitation, player information, available credit information, wager amount information, and other types of information that may or may not need to be recorded for purposes of accounting for wagers placed at the gaming device 108 and payouts made for a player 112 during a game of chance or skill played at the gaming device 108.

In some embodiments, the credit meter 324 may be configured to track coin in activity, coin out activity, coin drop activity, jackpot paid activity, bonus paid activity, credits applied activity, external bonus payout activity, ticket/voucher in activity, ticket/voucher out activity, timing of events that occur at the gaming device 108, and the like. In some embodiments, certain portions of the credit meter 324 may be updated in response to outcomes of a game of chance or skill played at the gaming device 108. In some embodiments, the credit meter 324 may be updated depending upon whether the gaming device 108 is issuing a ticket/voucher, being used as a point of redemption for a ticket/voucher, and/or any other activity associated with a ticket/voucher. Some or all of the data within the credit meter 324 may be reported to the gaming server 116, for example, if such data applies to a centrally-managed game and/or a status of a ticket/voucher. As an example, the number, value, and timing of wagers placed by a particular player 112 and payouts on such wagers may be reported to the gaming server 116.

Activities of the gaming device 108 related to ticket/voucher activity may be managed and reported by the ticket/voucher management instruction set 328. In some embodiments, when a ticket/voucher is redeemed at the gaming device 108 by the player 112, information associated with the ticket/voucher may be obtained by the ticket/voucher management instruction set 328 and reported to the gaming server 116. Furthermore, the ticket/voucher management instruction set 328 may be configured to update the credit meter 324 if the redeemed ticket/voucher is determined to be in a redeemable state and has a redeemable or redemption value associated therewith. In some embodiments, the credit meter 324 may be updated or incremented by the redeemable or redemption value of the ticket/voucher when redeemed. This information may be obtained directly from the ticket/voucher or may include some interactions (e.g., verification operations) with the gaming server 116 prior to updating the credit meter 324.

The gaming device 108 may be provided with appropriate hardware to facilitate acceptance and issuance of tickets/vouchers. Specifically, the gaming device 108 may be provided with a ticket acceptance device 352 that is configured to accept or scan physically-printed tickets/vouchers and extract appropriate information therefrom. In some embodiments, the ticket acceptance device 352 may include one or more machine vision devices (e.g., a camera, IR scanner, optical scanner, barcode scanner, etc.), a non-visual scanning device (e.g., an RFID reader, an NFC reader), a physical ticket acceptor, a shredder, etc. The ticket acceptance device 352 may be configured to accept physical tickets and/or electronic tickets without departing from the scope of the present disclosure. An electronic ticket/voucher may be accepted by scanning a visual code (e.g., a one-dimensional barcode, a two-dimensional barcode, any other type of barcode, a quick response (QR) code, etc.) displayed on a printed ticket/voucher or a communication device 145, for example. In another example, an electronic ticket/voucher may be accepted by scanning a tag (e.g., an RFID tag, an NFC tag, a contactless smart card, or the like) storing the ticket/voucher information.

The ticket issuance device 348 may be configured to print or provide physical tickets/vouchers to players 112. In some embodiments, the ticket issuance device 348 may be configured to issue a ticket/voucher consistent with an amount of credit available to a player 112, possibly as indicated within the credit meter 324. In some cases, the ticket/voucher may be an e-TITO voucher including a reprogrammable electronic display and an RFID tag.

The cash-in device 356 may include a bill acceptor, a coin acceptor, a chip acceptor or reader, or the like. In some embodiments, the cash-in device 356 may also include credit card reader hardware and/or software. In some aspects, the cash-in device 356 may include one or more machine vision devices (e.g., a camera, IR scanner, optical scanner, barcode scanner, etc.) or non-visual scanning devices (e.g., an RFID reader/writer, an NFC reader/writer).

The cash-out device 360, like the ticket issuance device 322, may operate and issue cash, coins, tokens, or chips based on an amount indicated within the credit meter 324. In some embodiments, the cash-out device 360 may include a coin tray or the like and counting hardware configured to count and distribute an appropriate amount of coins or tokens based on a player's 112 winnings or available credit within the credit meter 324. In some aspects, the cash-out device 360 may include one or more machine vision devices or non-visual scanning devices.

The memory 308 may be configured to store instruction sets, neural networks, and other data structures (e.g., depicted herein) in addition to temporarily storing data for the processor 304 to execute various types of routines or functions. For example, the memory 308 may be configured to store program instructions (instruction sets) that are executable by the processor 304 and provide functionality of a machine learning engine 332 described herein. The machine learning engine 332 may include example aspects of the machine learning engine 141 described with reference to FIG. 1.

One example of data that may be stored in memory 308 for use by components thereof is a data model(s) 336 and/or training data 340. The data model(s) 336 and the training data 340 may include examples of aspects of the data model(s) 142 and the training data 143 described with reference to the gaming server 116. The gaming device 108 (e.g., the machine learning engine 332) may utilize one or more data models 336 for recognizing and processing information obtained by the gaming device 108, another gaming device 108, a server (e.g., the gaming server 116), communication devices 145, and/or a database (e.g., player profile database 148, ticket/voucher database 152, and/or gaming device database 154). In some aspects, the gaming device 108 (e.g., the machine learning engine 332) may update one or more data models 336 based on learned information included in the training data 340.

In some aspects, components of the machine learning engine 332 may be provided in a separate machine learning engine (e.g., at server, for example, the gaming server 116) in communication with the gaming device 108.

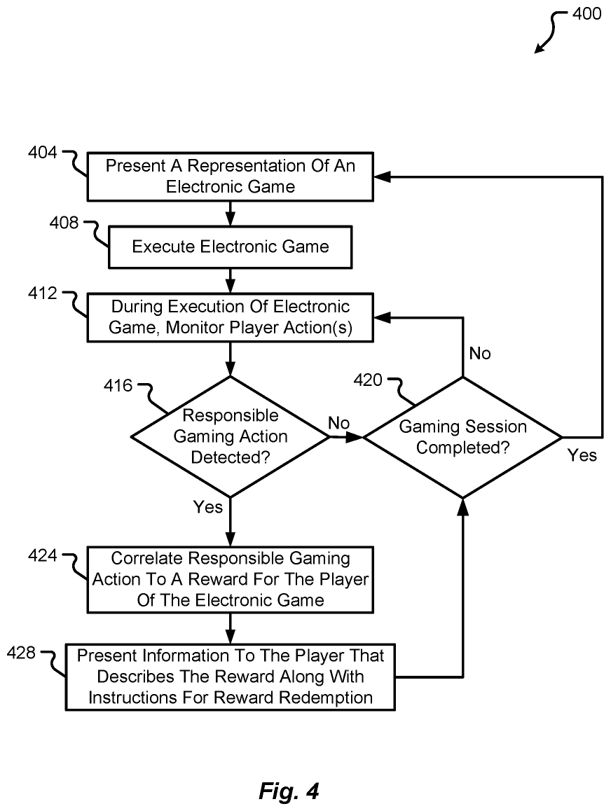

Referring now to FIGS. 4-12, example methods that support aspects of the present disclosure associated with incentivizing and rewarding responsible gaming behavior will be described. In some examples, some or all of a method may be performed at a single device (e.g., gaming server 116 or gaming device 108). Alternatively, a method may be performed by the cooperation of multiple devices without departing from the scope of the present disclosure.

In the following description of the methods, the operations may be performed in a different order than the order shown, or the operations may be performed in different orders or at different times. Certain operations may also be left out of a method, or other operations may be added to a method. It is to be understood that any device (e.g., a gaming device 108, a gaming server 116, a communication device 145, components of the system 100, etc.) may perform the operations depicted and described herein.

Referring initially to FIG. 4, a first responsible gaming method 400 will be described in accordance with at least some embodiments of the present disclosure. The method 400 begins with a gaming device 108 presenting a representation of an electronic game (step 404). In some embodiments, the presentation of the electronic game may include displaying a plurality of game features available in a game, when the game is played. In some embodiments, the presentation of the electronic game may include graphics and sounds that attract a player 112 to play the game. For instance, the initial presentation of a game and its associated features may be provided by the gaming device 108 operating in an “attract” mode.

The method 400 continues when a player 112 begins interacting with the gaming device 108 (e.g., at the user interface 316 of the gaming device 108). In some embodiments, the method 400 proceeds with the player 112 interacting with an appropriate button or input that indicates a desire to play the game. The electronic game may then be executed (step 408). The electronic game may correspond to a game of chance, a game of skill, a game of partial skill, or the like.

During execution of the game, the gaming device 108 may invoke its game instructions 320 as well as the responsible gaming engine 344. The responsible gaming engine 344 may be configured to monitor one or more player actions during execution of the game (step 412). For instance, the responsible gaming engine 344 may be configured to monitor in-game and/or non-game actions while the player 112 is involved in a gaming session at the gaming device 108.

Non-limiting examples of data that may be tracked as part of monitoring player in-game actions include player ID (e.g., via player tracking), player loyalty status, player in-game play behavior information (e.g., player average bet, average cash in, average play speed, etc.), in-game reactions of the player 112 after positive game events, such as high wins (e.g., player turns greedy and wastes the winnings immediately), in-game reactions of the player 112 after negative game events, such as lose streaks or bank running out of money (e.g., player turns immediately re-cashing in with an enormous money, aiming to earn their loss back), player biometric information (e.g., heart rate, blood pressure, stress level, nervousness level, etc.), player image data (e.g., an output of a camera), outputs of a smart device worn by the player 112, player direct feedback to a gaming event or gaming session (e.g., “How much did you like XY during your play?”) to get feedback, e.g., on reward measures taken by the system. Thus, the system could learn and self-adjust based on previous measures taken, to better satisfy the player 112 in the future.

Non-limiting examples of data that may be tracked as part of monitoring non-game actions include player ID (e.g., via player tracking), player information (e.g., player name, age, gender, financial income), player casino play behavior information (e.g., player average spend per visit, average time per visit, #different games played per visit, preferred games, preferred game volatility, etc.), player in-venue behavior using a surveillance tracking system (e.g., including personal ID tracking), average alcohol consumption, attitude towards aggressiveness (e.g., smashing onto machine), average player moving speed and “directness” towards a specific location (e.g., tend to walk significantly faster out of the casino after losing), player in-venue behavior as measured by microphones, player average noise level (e.g., player turning angry and loud after losing), player voice sentiment analysis (e.g., player starting to swear after losing). In some embodiments, a high wager to bank ratio for the player 112 may express a risky gaming session and, therefore, identify an irresponsible gaming behavior. Alternatively, a low wager to bank ratio for the player 112 may express a responsible gaming behavior.

While the player action(s) are monitored, the responsible gaming engine 344 may determine whether one or more actions correspond to a responsible gaming action (step 416). If the query of step 416 is answered negatively, then the method 400 proceed by determining if the gaming session is completed (step 420). If so, then the method 400 returns to step 404. If not, then the method returns to step 412.

In the event that the query of step 416 is answered positively, then the method 400 continues with the responsible gaming engine 344 correlating the responsible gaming action to a reward for the player 112 (step 424). The reward may be specifically selected based on a preference (e.g., an inferred preference or a stated preference) of the player 112. Alternatively or additionally, the reward may be generic to the game being executed or may be specific to the type of responsible gaming action detected. Suitable rewards include in-game rewards and non-game rewards. Examples of in-game rewards include, without limitation, financial rewards, free spins, reward enhancements (e.g., “Normally you would have won 5 free spins, but based on your healthy play behavior we want to thank you with 2 additional free spins”), exclusive game themes and skins, and/or “Magic Moments” of game play (e.g., a video recording) to recap positive feelings. Examples of non-game rewards include, without limitation, casino/venue rewards, cafeteria coupons, hotel stay coupons, wellness area coupons, free ticket to next casino event, exclusive access to particular machines, free pass to different assets of the venue, healthy gambler badges, steam like game achievements, loyalty points, casino staff congratulations, etc.

The method 400 may continue with the gaming device 108 presenting information to the player 112 that describes the reward along with instructions for redeeming the reward (step 428). In addition to providing information for reward redemption, the gaming device 108 may present other information to the player 112. For instance, the gaming device 108 may provide a survey or the like to the player 112. The survey may attempt to determine, among other things, information about the player's 112 general attitude in gaming (e.g., play to win money vs. play to see all bonus vs. play to spend time with friends vs. play to escape from daily life etc.), information about what the player 112 thinks when reacting to losing/winning (e.g., use information such as “I usually turn loud in voice when I lose” as an immediate, personal indicator that a person is becoming an unhealthy player), and/or information from the player 112 about what they would prefer being rewarded with when they exhibit responsible gaming behaviors. Thereafter, the method returns to step 420 to determine if the gaming session is completed or not.

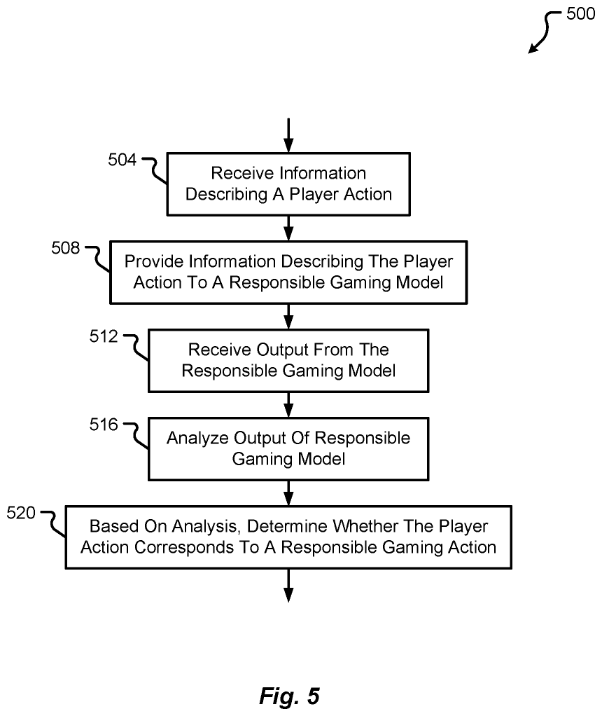

Referring now to FIG. 5, another gaming method 500 will be described in accordance with at least some embodiments of the present disclosure. The method 500 begins with the responsible gaming engine 344 receiving information describing a player action (step 504). The information may describe an in-game action and/or a non-game action. The player action (whether in-game or non-game) may have occurred during execution of a game.

The method 500 continues with the responsible gaming engine 344 providing information describing the player action to a responsible gaming model (step 508). For instance, the information describing the player action may be provided as training data 143, 340 to a data model 142, 336.

The method continues when the responsible gaming engine 344 receiving an output from the responsible gaming model (step 512). The output generated by the responsible gaming model may be generated based on the responsible gaming model processing the action data provided thereto.

The responsible gaming engine 344 may then analyze the output of the responsible gaming model (step 516). Analysis of the output may include comparing the output to one or more thresholds. Analysis of the output may also include providing the output or a portion thereof to an algorithm or rule set that is used to determine a current player health status (e.g., indicating the degree to which the player 112 is exhibiting responsible gaming behaviors).

Based on the analysis, the responsible gaming engine 344 may determine whether the player action(s) corresponds to a responsible gaming action (step 520). The determination may be made with specificity to the player or with reference to a more general/broad player population. As a non-limiting example, combining the various input parameters, and via player-casino-tracking, it may be possible to derive a “player health status” that indicates if and how responsible a player's 112 play behavior is (and has been during the casino visit), in real-time. To simplify readability (e.g., to avoid number interpretations) the player health status could be simplified to a smaller number of indicators or emoticons (e.g., “Green-Orange-Red” or “:)-:|-:(”). The player health status may be presented to the player 112 on their device 145 or via a gaming device 108. The player health status may also be used to trigger actions within the game, actions for the player 112, or actions for the casino operator.

Non-limiting actions that could be triggered in-game include prompting an on-screen message: “For your healthy play behavior you have been awarded XY”, asking the player to take a break and/or asking them to internalize what just happened (and reward them if the instructions were followed), providing a recommendation for a next step (e.g., after a losing streak or a total loss, recommend the player what to do next and reward them if they did so), predicting future gameplay with the current behavior, and if it tends to be going towards unhealthy play behavior, informing the player about the prediction. For instance, the player 112 may be asked to stop playing or change their behavior by taking particular steps (e.g., decreasing bet, stop using a gamble feature, etc.) and reward them if they did so. A casino operator may be notified about players with explicitly responsible gaming behaviors. A casino operator may also be provided with a responsible play heatmap of all players in the casino. The heatmap may identify, for example, a location of each player and that player's associated player health status. The heatmap may also provide the casino operator with proposed actions to reward the player 112 (e.g., rewards player 112 with reward X, distract player 112 with a conversation, etc.).

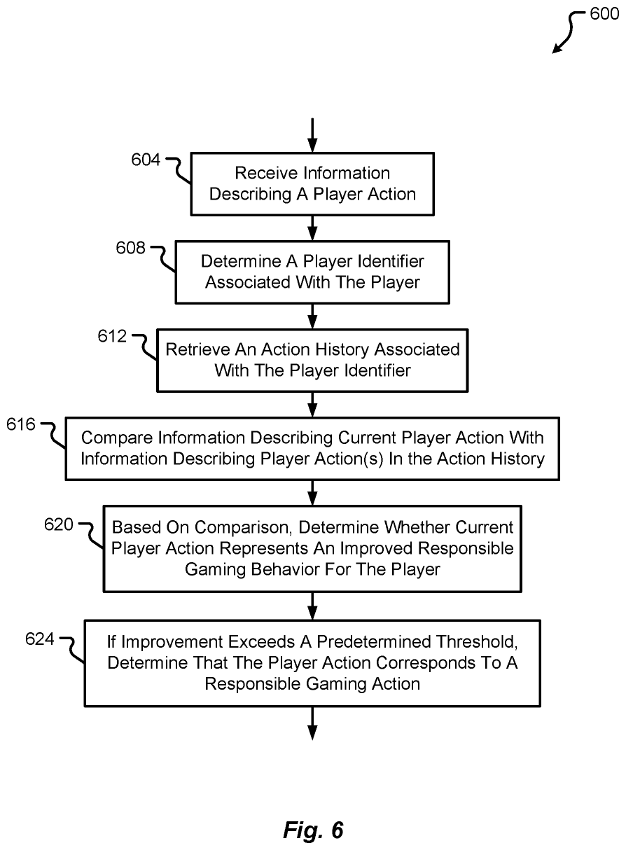

Referring now to FIG. 6, yet another method 600 will be described in accordance with at least some embodiments of the present disclosure. The method 600 begins when information describing an action of a player 112 is received (step 604). The method 600 continues by determining a player identifier associated with the player 112 (step 608). The player identifier may be determined with reference to a player profile database 148 and/or by utilizing player tracking capabilities. Alternatively or additionally, the player identifier may be determined prior to receiving information describing the player action. For instance, a player may card-in or login to a gaming device 108 prior to initiating a gaming session. During the card-in or login event, the player 112 may provide a player identifier to the gaming device 108, which is stored in memory 308 until the player 112 completes the gaming session and logs out.

The method 600 continues by retrieving an action history associated with the player identifier (step 612). Information describing the current player action may then be compared with information describing player action(s) in the action history (step 616). For instance, the player action may be compared with a number of actions that have occurred over a period of time to determine if the current action is consistent (e.g., substantially similar to) with previous actions. In some embodiments, the method 600 may include determining, based on the comparison, whether the current player action represents an improved responsible gaming behavior for the player 112 (step 620).

In some embodiments, if an improvement exists as compared to past behaviors and if that improvement exceeds a predetermined threshold, then the method 600 may continue by determining that the current player action corresponds to a responsible gaming action (step 624). As discussed herein, if the current player action is determined to be a responsible gaming action, then the method may further include rewarding the player with one or more appropriate rewards.

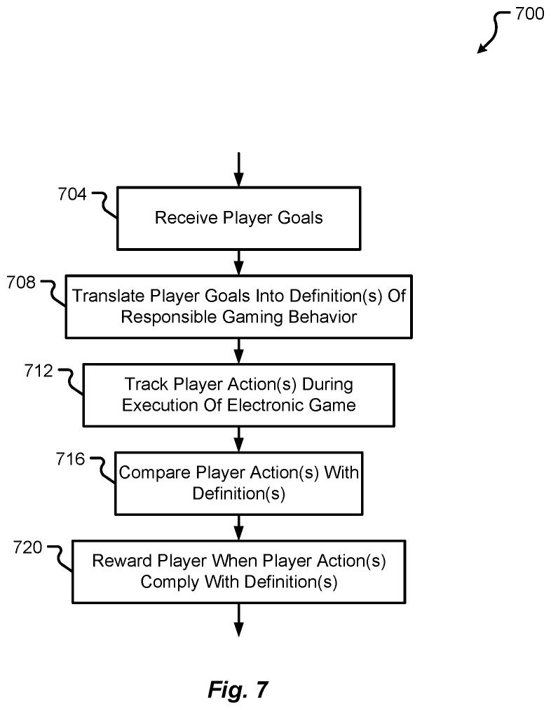

Referring now to FIG. 7, another method 700 will be described in accordance with at least some embodiments of the present disclosure. The method 700 begins with the responsible gaming engine 344 receiving player goals (step 704). In some embodiments, the player goals may relate to responsible gaming goals. The player goals may include positive goals (e.g., exhibit more responsible gaming behaviors) or negative goals (e.g., avoid irresponsible gaming behaviors). In some embodiments, the player goals may be translated into one or more definitions of a responsible gaming behavior (step 708). For example, a player goal may indicate a desire to not spend all of their cash on hand. Such a goal could be translated to determining that the player cashes out after a win, does not wager all of their winnings after a big win, or cashes out before their credit meter balance hits zero.

The player 112 actions may be tracked during execution of an electronic game (step 712). Specifically, in-game and non-game actions may be tracked for the player 112 while the player 112 is involved in a gaming session. The player action(s) may be compared with the definitions developed based on the player's 112 personalized goals (step 716). In some embodiments, if the responsible gaming engine 344 detects an action that aligns with the definitions developed based on the player's 112 personalized goals, the player 112 may be provided with a reward (step 720).

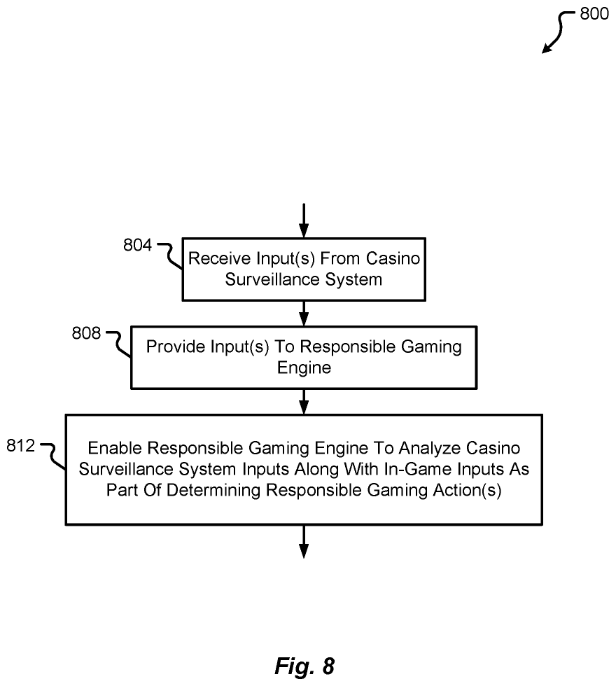

Referring now to FIG. 8, another method 800 will be described in accordance with at least some embodiments of the present disclosure. The method 800 may include receiving one or more surveillance system inputs at a centralized location (e.g., the gaming server 116) (step 804). The surveillance system inputs may correspond, at least in part, to data that is useable to assess player actions. In some embodiments, the surveillance system inputs may include camera inputs, microphone inputs, and other inputs known to be used within a surveillance system. The surveillance system inputs may then be provided to the responsible gaming engine 344 (step 808).

The responsible gaming engine 344 may then be enabled to analyze surveillance system inputs along with other actions (e.g., in-game actions) as part of determining whether a player 112 is exhibiting responsible gaming behaviors (step 812).

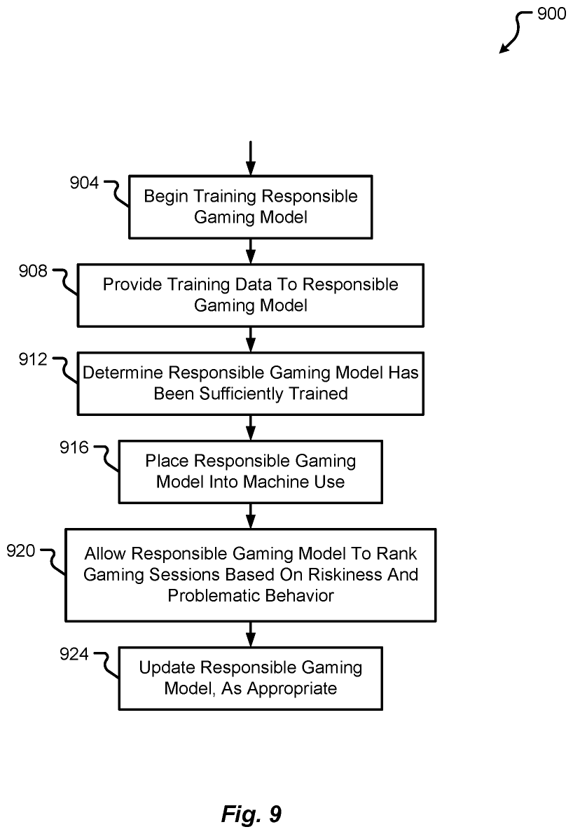

Referring now to FIG. 9, additional details related to building, training, and maintaining a responsible gaming model will be described in accordance with at least some embodiments of the present disclosure. A training method 900 is initiated when a data model 142, 336 is determined to be trained as a responsible gaming model (step 904). The model may be provided with training data 143, 340 as previously described herein (step 908). The model may be provided with an amount of training data and may be trained for an amount of time.

The model may continue to undergo training until it has been determined that the model has been sufficiently trained (step 912). A model may be deemed sufficiently trained after the model begins to produce reliable or predictable outputs, after the model has been provided a predetermined amount of training data, after the model has been trained for a predetermined amount of time, after a predetermined number of model outputs align with expected outputs (e.g., the model identifies an action as responsible and that same action is also identified as responsible by a qualified human).

Once the model is sufficiently trained, the method 900 may continue by placing the model into a gaming device 108 as a production data model 336 (step 916). Alternatively or additionally, the trained model may be placed into the gaming server 116 as a production data model 142. The trained data model may then be used as a responsible gaming model to rank gaming sessions and assess player actions based on riskiness and problematic behavior(s) (step 920). The method 900 may also include updating the responsible gaming model, as appropriate (step 924). For instance, additional data models may be trained in parallel with use of the responsible gaming model and outputs of the additional data models may be compared with outputs of the responsible gaming model in production. If one or more of the additional data models begin producing better outputs or more reliable outputs, then the better-performing model may replace the responsible gaming model in production.

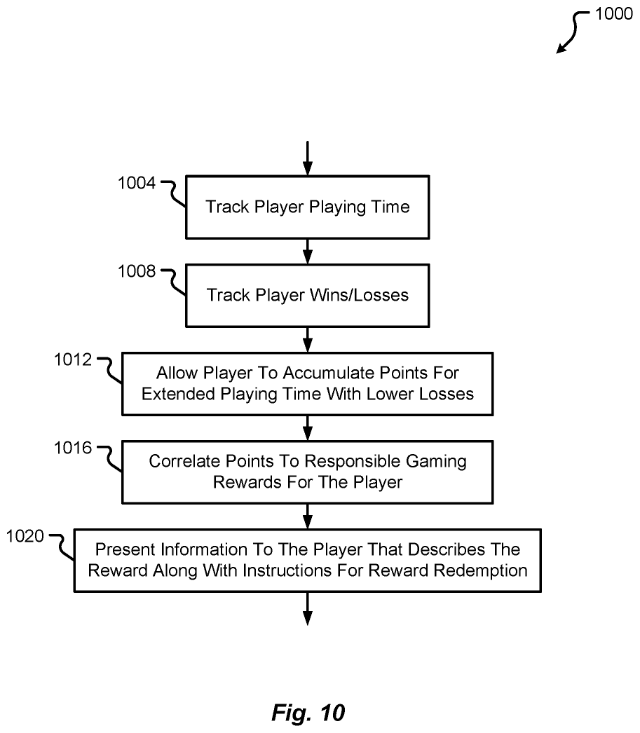

With reference now to FIG. 10, another method 1000 will be described in accordance with at least some embodiments of the present disclosure. The method 1000 may involve incentivizing player behavior based on a formula combining lowering of financial losses and longer playing time. Thus, the method 1000 may include tracking player playing time (step 1004) as well as player win/losses (step 1008). For example, the longer a player 112 plays and the lower their losses are, the more points they will accumulate step 1012).

As the player 112 continues to play the game, the player 112 may be allowed to accumulate responsibility points. The points may be correlated to responsible gaming rewards, as described herein (step 1016). For instance, responsible gaming points can be redeemed for discounts on other casino amenities such as reduced room rates, meal discounts, show tickets, etc. In this way, the casino will benefit by this behavior due to the player spending in other areas of the casino. It should also be appreciated that the formula used to allow point accumulation may be customized on a per-player basis. For instance, the formula would be customized to each player, based on their play habits and any other player demographic information available to the casino.

As the player 112 accumulates points and earns rewards, the player 112 may be presented with information that describes the reward as well as instructions for redeeming the reward (step 1020).

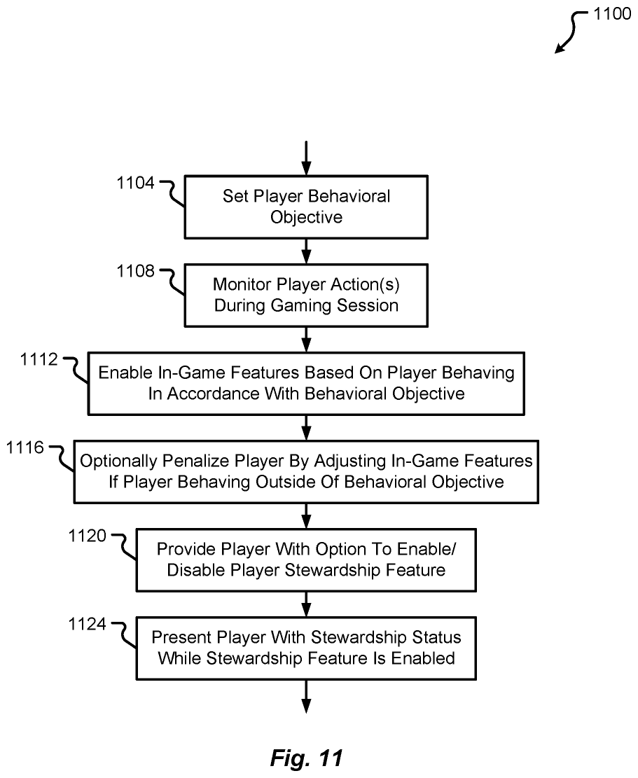

Referring now to FIG. 11, yet another method 1100 will be described in accordance with at least some embodiments of the present disclosure. The method 1100 begins with the setting of a behavioral objective (step 1104). The behavioral objective may be set by the player 112 themselves, by a casino operator, by a counselor of the player 112, or the like. Examples of a behavioral objective include, without limitation, ensuring gaming session longevity, avoiding player bankruptcy, etc.

The method 1100 may continue by monitoring player action(s) during a gaming session (step 1108). Such actions may include in-game actions and non-game actions. As player actions are monitored, certain in-game features may be enabled for the player 112 based on the player 112 behaving in accordance with one or more of their behavioral objectives (step 1112). Such features may not otherwise be available to the player 112. Conversely and optionally, the method 1100 may also include penalizing the player 112 by adjusting or revoking certain in-game features if the player 112 is behaving outside of their behavioral objectives (step 1116). Examples of in-game features that may be given or revoked include, without limitation, limit available bet options (e.g., reduce higher ones), restrict amount to be cashed in at a time (e.g., bank note limits), make reel-spin slower to decrease max number of games per minute, etc.

The method 1100 may also include a step where the player 112 is provided with an option to enable/disable their stewardship feature (e.g., the feature controlling in-game features based on compliance with behavioral objectives) (step 1120). The method 1100 may also include presenting the player 112 with a status of their stewardship while the stewardship feature is enabled (step 1124). For instance, the player 112 may be presented with a behavioral indicator that shows whether the player's 112 current actions are aligned with responsible gaming behavior, neutral gaming behavior, or irresponsible gaming behavior.

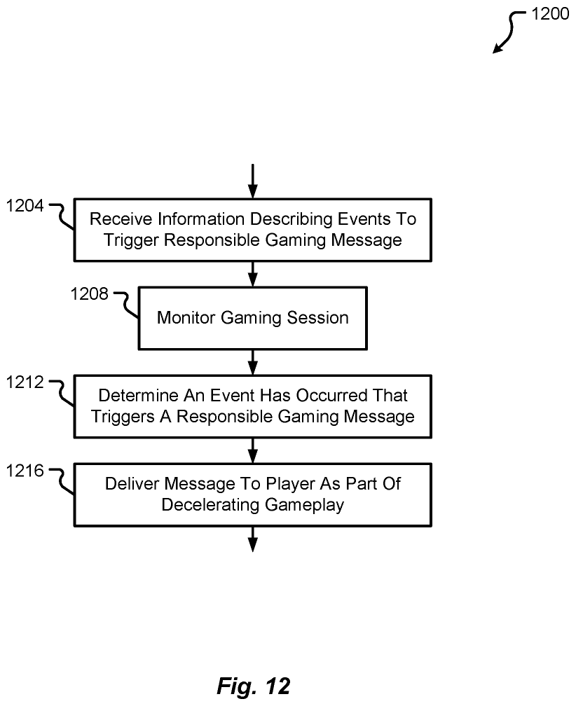

With reference now to FIG. 12, another method 1200 will be described in accordance with at least some embodiments of the present disclosure. The method 1200 begins when information describing events that trigger a responsible gaming message are received (step 1204). After receiving information describing the event, the gaming device 108 may attempt to monitor the player's 112 gaming session (step 1208) and determine if one or more events have occurred that trigger a responsible gaming message (step 1212). For example, after a defined event, the gaming device 108 may be configured to distract the player 112 from the event. In this time the player can recap the situation. One example of an event that may benefit from a distraction for the player 112 include, without limitation, a series of losses, which may cause the gaming device 108 to offer the player 112 to have a drink at the bar and review the financial situation there (step 1216). Another example of an event may include delivering a message to the player after a large win in which the gaming device 108 congratulates the player 112 and asks if he knows what he will do with the winnings. In some embodiments, the gaming device 108 may propose some options for saving or spending the winnings.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T−1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for operating an electronic game, the method comprising:
presenting, by a processor, a representation of the electronic game on a display device, wherein the representation of the electronic game includes displaying a plurality of game features;
executing, by the processor, the electronic game;
determining, during execution of the electronic game, that a player of the electronic game has taken an action that corresponds to a responsible gaming action;
correlating the responsible gaming action to a reward for the player; and
presenting, by the processor, information to the player that describes the reward for the player along with instructions for redeeming the reward.

2. The method of claim 1, wherein determining that the player of the electronic game has taken the action that corresponds to the responsible gaming action comprises:
determining, with the processor, a player identifier associated with the player;
retrieving an action history associated with the player identifier; and
determining that the responsible gaming action represents an improved gaming behavior with respect to the action history associated with the player identifier.

3. The method of claim 2, wherein the improved gaming behavior indicates an ability of the player to better control an amount wagered during execution of the electronic game as compared to an ability of the player to control wagers made in the action history.

4. The method of claim 1, wherein the reward comprises an additional game feature presented to the player during execution of the electronic game and wherein the additional game feature is unavailable to the player during execution of the electronic game in an absence of determining that the player of the electronic game has taken the action that corresponds to the

5. The method of claim 1, wherein the reward comprises an out-of-game reward that is made available to the player outside of the electronic game and wherein the instructions for redeeming the reward include the player discontinuing play of the electronic game for at least a period of time.

6. The method of claim 1, further comprising:
maintaining a responsible gaming model;
providing in-game actions taken by the player during execution of the electronic game to the responsible gaming model;
receiving an output from the responsible gaming model based on the responsible gaming model processing the in-game actions; and
using the output from the responsible gaming model as part of determining that the player of the electronic game has taken the action that corresponds to the responsible gaming action.

7. The method of claim 6, wherein the responsible gaming model is trained with a combination of gameplay data and psychologist input data.

8. The method of claim 6, wherein the responsible gaming model comprises a recurrent neural network.

9. The method of claim 8, wherein the recurrent neural network is fed Nth latest actions and outcomes of gaming sessions with which the player is associated.

10. The method of claim 1, wherein the electronic game comprises a game of chance.

11. The method of claim 1, wherein the electronic game comprises a game of skill.

12. The method of claim 1, wherein the display device is provided as part of an Electronic Gaming Machine (EGM).

13. The method of claim 1, wherein the display device is provided as part of a mobile device.

14. A system, comprising:
a processor; and
a memory coupled with and readable by the processor and having stored thereon instructions which, when executed by the processor, cause the processor to:
execute an electronic game, wherein the electronic game presents a plurality of game features to a player during execution thereof;
determine, during execution of the electronic game, that the player has taken an action that corresponds to a responsible gaming action;
correlate the responsible gaming action to a reward for the player; and
present information to the player that describes the reward for the player along with instructions for redeeming the reward.

15. The system of claim 14, wherein the instructions further cause the processor to:
determine a player identifier associated with the player;
retrieve an action history associated with the player identifier; and
determine that the responsible gaming action represents an improved gaming behavior with respect to the action history associated with the player identifier.

16. The system of claim 15, wherein the improved gaming behavior indicates an ability of the player to better control an amount wagered during execution of the electronic game as compared to an ability of the player to control wagers made in the action history.

17. The system of claim 14, wherein the reward comprises an additional game feature presented to the player during execution of the electronic game and wherein the additional game feature is unavailable to the player during execution of the electronic game in an absence of determining that the player of the electronic game has taken the action that corresponds to the

18. The system of claim 14, wherein the reward comprises an out-of-game reward that is made available to the player outside of the electronic game and wherein the instructions for redeeming the reward include the player discontinuing play of the electronic game for at least a period of time.

19. The system of claim 14, wherein the instructions further cause the processor to:
provide in-game actions taken by the player during execution of the electronic game to a responsible gaming model;
receive an output from the responsible gaming model based on the responsible gaming model processing the in-game actions; and
use the output from the responsible gaming model as part of determining that the player of the electronic game has taken the action that corresponds to the responsible gaming action.

20. A gaming device, comprising:
a display device;
a processor coupled with the display device; and
a memory coupled with and readable by the processor and having stored thereon instructions which, when executed by the processor, cause the processor to:
present a representation of an electronic game on the display device, wherein the representation of the electronic game includes displaying a plurality of game features;
execute the electronic game;
determine, during execution of the electronic game, that a player of the electronic game has taken an action that corresponds to a responsible gaming action;
correlate the responsible gaming action to a reward for the player; and
present information to the player that describes the reward for the player along with instructions for redeeming the reward.
